(19) United States
(12) Patent Application Publication
(10) Pub. No.: US 2018/0003065 A1
(43) Pub. Date: Jan. 4, 2018

(54) TURBINE ENGINE WHEEL

(71) Applicant: Safran Helicopter Engines, Bordes (FR)

(72) Inventor: Elena COLLADO MORATA, Moissy-Cramayel (FR)

(73) Assignee: Safran Helicopter Engines, Bordes (FR)

(21) Appl. No.: 15/260,719

(22) Filed: Sep. 9, 2016

(30) Foreign Application Priority Data
Jun. 29, 2016 (FR) 1656116

(51) Int. Cl. F01D 9/04; F01D 11/00

(52) U.S. Cl. CPC F01D 9/041; F01D 11/003; F05D 2220/32

(57) ABSTRACT

The invention relates to a turbine wheel (34) comprising a plurality of vanes connected to an annular platform (24) carrying annular lips (36, 38). According to the invention, one of the upstream lip (38) and the downstream lip (36) is of a first type or of a second type, with the first type corresponding to one lip (36) having the upstream face (36a) which is concave curved and the downstream face (36b) which is convex curved and the second type corresponding to a lip (38) having the upstream (38a) and downstream (38b) faces which are substantially flat and mutually parallel.

The invention relates to a wheel of a turbine engine, such as a turbine wheel, as well as a turbine engine comprising such a wheel.

Conventionally, a turbine engine comprises a so-called primary annular air circuit and a so-called secondary annular circuit. The primary air circuit extends in the downstream direction through low and high pressure compressors, a combustion chamber and a high then a low pressure turbine.

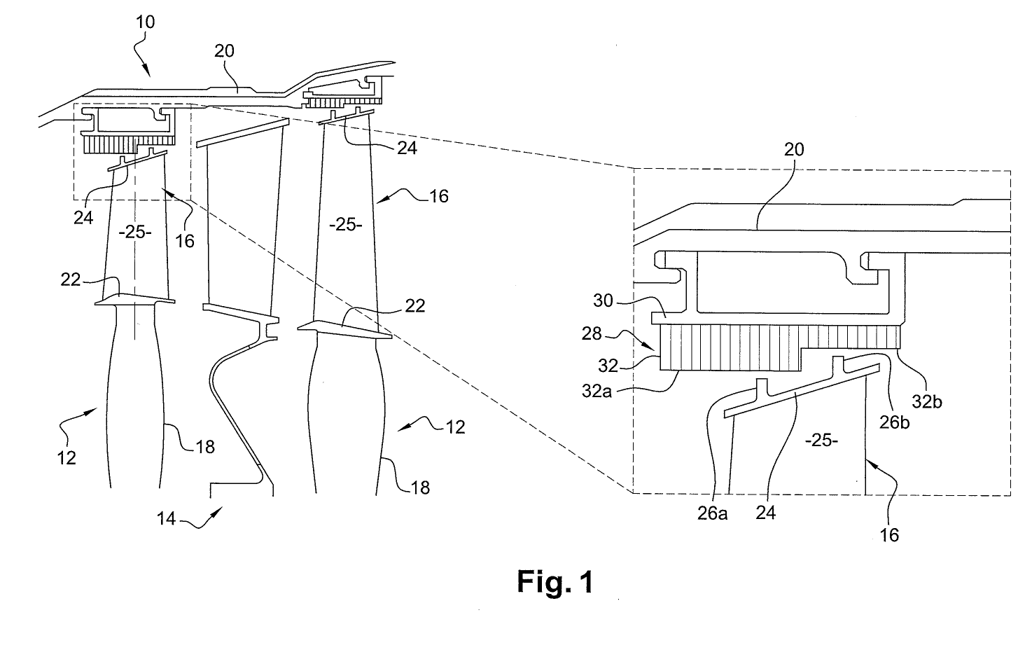

As shown in FIG. 1, the low pressure turbine 10 comprises a plurality of wheels 12 axially positioned so as to alternate with annular rows of stator vanes 14. The wheels 12 comprise vanes 16 carried by discs 18 integral with each other through the shaft of a low pressure turbine rotatingly driving the shaft of a fan or power shaft and the low pressure compressor. The vanes 14 of the stator are radially carried outwards by a casing of the turbine 20.

More specifically, the right part of FIG. 1 shows the enlarged area defined by dots on the left part of the same figure. Each turbine wheel 12 comprises a radially internal annular platform 22 and a radially external annular platform 24 between which a vane 25 extends, with such platforms 22, 24 possibly consisting of a plurality of sections of platforms juxtaposed one after the other on the circumference to define the internal and external limits of the primary air flow. The external platform 24 comprises lips 26a, 26b radially extending outwards towards an abradable panel 28 carried by the turbine casing 20 and consisting of a wall 30 supporting an alveolar so-called honeycomb structure 32.

As can be seen in FIG. 1, the alveolar structure 32 may have two friction tracks 32a, 32b of the lips 26a, 26b, with a first one 32a being arranged upstream and radially inside a second one 32b arranged downstream of the first one 32a. In such a configuration, the upstream lip 26a thus extends over a distance radially smaller than the downstream lip 26b.

It has been noted that the sealing between the lips 26a, 26b and the tracks 32a, 32b of the abradable material 28 was not satisfactory. Lips sloping in the upstream direction between their internal and external ends have thus been provided for. However, such lips are not totally satisfactory since parasitic circulations of air still remain between the abradable material and the radially external ends of the lips.

A need therefore exists to improve the sealing performances at this place in a turbine engine so as to increase the output of the turbine engine.

The invention aims at providing a simple, economical and efficient solution to the above-mentioned problems.

For this purpose, it provides a wheel of a turbine engine comprising a plurality of radially extending vanes, one radially internal or external end of which is connected to an annular platform carrying annular lips extending from said platform in a direction opposite the vane between a first radial end connected to the platform and a second opposed radial free end, in order to sealingly cooperate with a radially facing ring, characterized in that one of the upstream lip and of the downstream lip is of a first type or of a second type, with the first type corresponding to one lip having the upstream face which is concave curved and the downstream face which is convex curved and the second type corresponding to a lip having the upstream and downstream faces which are substantially flat and mutually parallel, with the first end of said lip being arranged downstream from the second end.

Integrating a lip of the first type or of the second type at one of the upstream or downstream ends makes it possible to reduce the parasitic flow of air radially circulating between the wheel and the radially opposed ring by inducing a recirculation of the air flow impacting the lip in the upstream direction. Such reduction in the air flow is more important when the lip according to the invention is integrated at the upstream or downstream end of the platform. In practice, when air impacts the upstream face of the lips, the latter rotates counterclockwise, which tends to recirculate air in the upstream direction and thus limits the circulations of air between the lip and the abradable material.

In a preferred embodiment of the invention, said lip is arranged at the downstream end of said platform. Such position reveals more efficient as regards the reduction in the parasitic flow of air than a positioning at the upstream end.

Besides, the reduction in the parasitic flow of air is further increased when said downstream lip is of the first type.

In this configuration, integrating another annular lip of the second type mentioned above, at the upstream end of the platform may be interesting. Such mixed mounting with a lip at the downstream end which is of the first type and a lip of the second type at the upstream end makes it possible to obtain a significant reduction in the parasitic air flow while avoiding complications in the production of the platform with lips, since it requires only one lip of the first type which is more difficult to produce than the lip of the second type.

In one embodiment of the invention, the generatrix of the cone of revolution going through the first end and the second end is obliquely inclined relative to a plane perpendicular to the axis of the wheel by a value strictly greater than 0° and smaller than or equal to 60°, preferably between 15° and 45° and more preferably of the order of 30°.

According to another characteristic of the invention, the upstream and downstream faces of the lip of the first type have a substantially constant radius of curvature between the first end and the second end thereof.

The invention also relates to a turbine of a turbine engine, such as a high pressure turbine, comprising at least one mobile wheel of the type disclosed above.

It also comprises turbine engine, such as a turboprop engine or a turbojet engine, comprising such a turbine.

The invention will be better understood other details, characteristics, and advantages of the invention will appear on reading the following description given by way of non-limiting example and with reference to the accompanying drawings, in which:

FIG. 1 already describe above, is a schematic sectional view of a low pressure turbine according to the prior art;

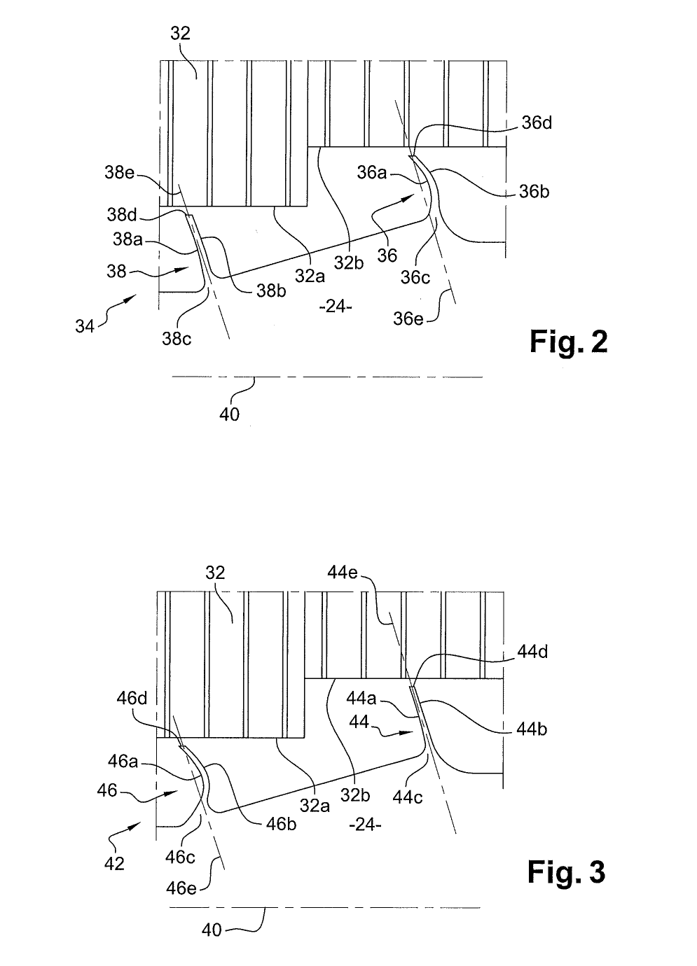

FIGS. 2 and 3 are schematic sectional views of the radially external end of a turbine wheel according to the invention and according to two alternative embodiments.

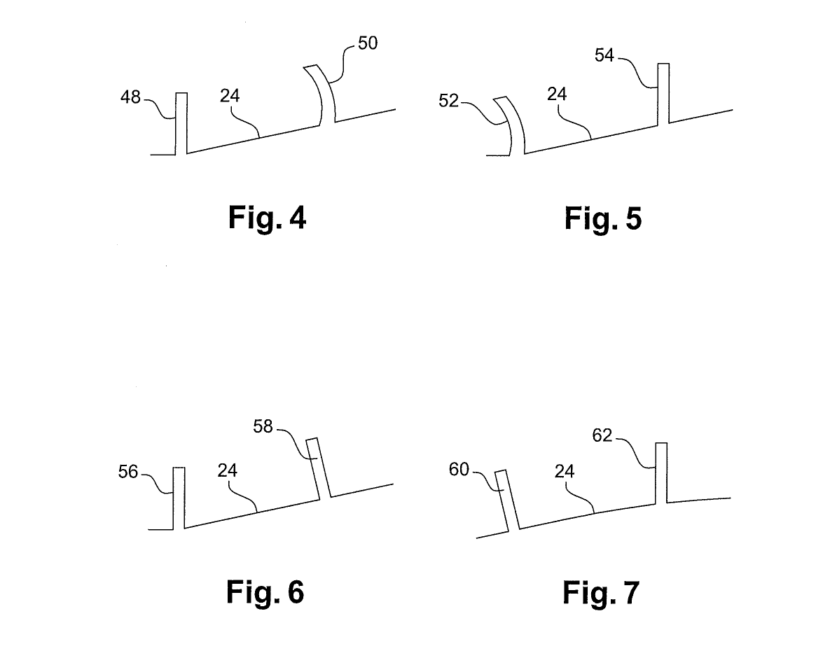

FIGS. 4, 5, 6 and 7 depict alternative embodiments of the invention.

Reference is first made to FIG. 2 which shows the radially external end of a turbine wheel 34 according to the invention comprising a downstream annular lip 36 and an upstream annular lip 38.

As can clearly be seen in this figure, the downstream lip 36 is of a first type, which is different from the second type of the upstream lip 38. The downstream lip 36 comprises a concave curved upstream face 36a and a second convex curved downstream face 36b. The upstream lip 38 comprises an upstream face 38a and a downstream face 38b which are flat and substantially mutually parallel. Each upstream 38 and downstream 36 lip has a first radial end 36c, 38c, which is connected to the platform 24 and a second radial end 34d, 36d, 38d opposed to said first end 36c, 38c, and forming a free end intended to sealingly rub the alveolar structure 32 of the abradable material 28 as already mentioned above when referring to FIG. 1.

The first end 36c, 38c of each one of the downstream lip 36 and the upstream lip 38 is arranged downstream of its second end 36d, 38d, with such axial shift being represented in FIG. 2 by dotted line 36e, 38e passing through said first end 36c, 38c and second end 36d, 38d of the upstream 38 and downstream 36 lips. Such lines 36e, 38e are thus obliquely inclined in the upstream direction relative to a plane perpendicular to the axis 40 of the wheel 34. The upstream lip thus defines a first lip type and the downstream lip defines a second lip type.

When air impacts the upstream face 36a, 38a of the lips 36, 38, the latter rotates counterclockwise, which tends to recirculate air in the upstream direction and thus limits the circulations of air between the lip 36, 38 and the abradable material 32.

In a second embodiment of a turbine wheel 42 according to the invention, as shown in FIG. 3, the downstream 44 lip is of the second type, i.e. with an upstream face 44a and a downstream face 44b which are flat and mutually parallel, whereas the upstream lip 46 is of the first type, i.e. with a concave curved upstream face 46a and a convex curved downstream face 46b. Both upstream 46 and downstream 44 lips comprise a first radial end 44c, 46c and a second radial end 44d, 46d, with the first ends 44c, 46c being also axially shifted in the downstream direction relative to the second radially external end 44d, 46d. The upstream 46 and downstream 44 lips are thus obliquely inclined in the upstream direction relative to a plane perpendicular to the axis 40 of the wheel 42.

It should be noted that the design of the wheel in FIG. 2 makes it possible to reach a better reduction in the parasitic flow of air as compared to the design of the wheel in FIG. 3. As a matter of fact, it has been noted that the total flow of air circulating between the radially external end of the wheel and the abradable material is more significantly reduced when the downstream lip is of the first type or the second type, which proves that providing a perfect sealing on the last lip is particularly important, and that such reduction is even more important when the downstream lip 36 is of the first type.

The radius of curvature of the upstream 36a, 46a and downstream 36b, 46b faces of the lips of the first type may be substantially constant between the first end and the second end of a lip.

Preferably, the slope of the lips 36, 38, 44, 46 is such that the generatrix of the cone of revolution going through the first end 36c, 38c, 44c, 46c and the second end 36d, 38d, 44d, 46d is inclined relative to a plane perpendicular to the axis 40 of the wheel 34, 42 by a value strictly greater than 0° and smaller than or equal to 60°, preferably between 15° and 45° and more preferably of the order of 30°.

When reading the above description, it should be understood that the turbine wheel 34, 42 could comprise a number of annular lips above two, as is shown in the figures, with such embodiments being an integral part of the subject of the invention. Besides, if, in the embodiments shown in FIGS. 2 and 3, each wheel 34, 42 comprises lips of a first type and of a second type, each wheel 34, 42 may also comprise a lip of the first type at the upstream or downstream end thereof, or a lip of the second type at the upstream or downstream end thereof, without departing from the subject of the invention.

In the embodiments described above, the lips 36, 38, 44, 46 have been presented as being annular. This of course should be understood as indicating that the lip annually extend over 360° and may consist of a plurality of sectors of lips juxtaposed one after the other on the circumference.

FIGS. 4, 5, 6 and 7 depict alternative embodiments of the invention.

In FIG. 4, the upstream annular lip 48 extends substantially radially outwards from the platform 24 and the downstream annular lip 50 is of the first type. In FIG. 5, the upstream annular lip 52 is of the first type and the downstream annular lip 54 extends substantially radially outwards from the platform 24. In FIG. 6, the upstream annular lip 56 extends substantially radially outwards from the platform 24 and the downstream annular lip 58 is of the second type. In FIG. 7, the upstream annular lip 60 is of the second type and the downstream annular lip extends substantially radially outwards from the platform 24.

Although the invention has been disclosed above with respect to an abradable annular element, it should be understood that it can also be applied to any embodiment wherein the lip(s) sealingly cooperate with an annular part which may be smooth and which is not provided to specifically wear when in contact with the lips such as an abradable material.

1. A wheel of a turbine engine comprising a plurality of radially extending vanes, one radially internal or external end of which is connected to an annular platform carrying annular lips extending from said platform in a direction opposite the vane between a first radial end connected to the platform and a second opposed radial free end, in order to sealingly cooperate with a radially facing ring, wherein one of the upstream lip and of the downstream lip is of a first type or of a second type, with the first type corresponding to one lip having the upstream face which is concave curved and the downstream face which is convex curved and the second type corresponding to a lip having the upstream and downstream faces which are substantially flat and mutually parallel, with the first end of said lip being arranged downstream of the second end for both the first type and the second type.

2. A wheel according to claim 1, wherein said lip is arranged at the downstream end of said platform.

3. A wheel according to claim 2, wherein said lip is of the first type.

4. A wheel according to claim 3, further comprising another annular lip arranged at the upstream end of the platform, with the other lip being of the second type.

5. A wheel according to claim 1, wherein the generatrix of the cone of revolution going through the first end and the second end of the lip is inclined relative to a plane perpendicular to the axis of the wheel by a value strictly greater than 0° and smaller than or equal to 60°.

6. A wheel according to claim 1, wherein the upstream and downstream faces of the lip of the first type have a substantially constant radius of curvature between the first end and the second end.

7. The turbine of a turbine engine, such as a high pressure turbine, comprising at least one mobile wheel according to claim 1.

8. A turbine engine, such as a turboprop engine or a turbojet engine, comprising a turbine according to claim 7.

9. A wheel according to claim 1, wherein the generatrix of the cone of revolution going through the first end and the second end of the lip is inclined relative to a plane perpendicular to the axis of the wheel by a value between 15° and 45°.

10. A wheel according to claim 1, wherein the generatrix of the cone of revolution going through the first end and the second end of the lip is inclined relative to a plane perpendicular to the axis of the wheel by a value on the order of 30°.
